(19) United States
(12) Patent Application Publication
(10) Pub. No.: US 2024/0185091 A1
(43) Pub. Date: Jun. 6, 2024

(54) ROBUST ENTITY MATCHING USING MACHINE LEARNING MODELS TRAINED ON HISTORICAL CUSTOMER DATA

(71) Applicant: SAP SE, Walldorf (DE)

(72) Inventors: Stefan Klaus Baur, Heidelberg (DE); Matthias Frank, Heidelberg (DE); Hoang-Vu Nguyen, Leimen (DE)

(21) Appl. No.: 18/074,574

(22) Filed: Dec. 5, 2022

(51) Int. Cl. G06N 5/022; G06Q 30/0201

(52) U.S. Cl. CPC G06N 5/022; G06Q 30/0201

(57) ABSTRACT

Disclosed herein are system, method, and computer program product embodiments for dropping or replacing data from datasets and training ML models to avoid overfitting in training data. An embodiment operates by generating a first set of data, wherein the first set of data may include a first plurality of entities. The first set of data may be modified by processing the first set of data, which results in a second set of data. The second set of data may include a second plurality of entities. The second set of data may be extracted to be used in a machine learning (ML) process based at least in part on at least one ML model. The second set of data may be trained on at least one ML model. A third set of data may be predicted based on the at least one ML model. The third set of data may include a third plurality of entities. The first, second, and third plurality of entities may be classified by a class.

### BACKGROUND

In enterprise applications (EAs) that use machine learning (ML) models, the ML models are often trained on historical data. The historical data may include historical records, which are often modified over time such that the historical records used for training are statistically different from ones used at an inference time.

A field may be filled at a point in a business process such that it is empty at the inference time. However, this field may be filled with information after the inference time, and this modified form will be part of the training data that are later extracted from a database or storage. The features filled in may be used for training that contains information that becomes available only after a prediction step. The ML model learns to exploit the information that will not be present when later applying the ML model to predict new data in a production setting. Often ML model performance in actual production is significantly worse than what is expected from a validation and test dataset taken from the training set.

### BRIEF DESCRIPTION OF THE DRAWINGS

The accompanying drawings are incorporated herein and form a part of the specification.

FIG. 1 depicts an illustration of a process for dropping or replacing data from datasets and training ML models to avoid overfitting in training data over time, according to some embodiments.

FIG. 2 depicts a real world example of an entity matching problem, according to some embodiments.

FIG. 3 illustrates a method of entity matching by dropping or replacing data from datasets and training ML models to avoid overfitting in training data, according to some embodiments.

FIG. 4 is an example computer system useful for implementing various embodiments, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for dropping or replacing data from datasets and training ML models to avoid overfitting in training data.

In the present disclosure, data augmentation during ML training may be realized. Specifically, features may be present in a dataset and may be modified by dropping features or replacing features with dummy values in a randomized way so that each feature has a small probability of being dropped. A feature may be a column in an entity table. Alternatively, an entity may correspond to a row in such an entity table. Specifically, a table of incoming payments may be provided along with another table of invoices. Each payment of the incoming payments may be the entity and each entity (payment) may be composed of several features such as, but not limited to, amount, memo-line, amount, etc. The invoices themselves in the table of invoices may be an entity as well.

Training with the modified data using the data augmentation technique may allow for avoiding model overfitting on certain patterns that may only be present in the training data, but not in the production data. Strategies to alleviate such a domain shift, such as ML model performance in actual production being worse than what is expected, may be achieved by using data augmentation on a training set. Embodiments of the present disclosure may be relevant to generic or automated ML services, also known as AutoML, which may be adapted in many situations where models must be robust against accidental inclusion of information leaking features.

A ML model may classify a set as a sample characterized by a set of features, which may be derived from fields of a database table. The set of features may also be referred to as an entity. The set of features may be classified by assigning each of K classes a probability-like confidence value p. This value may be, for example:

$${f}_{\vec{w}} ( \vec{a} ) = \vec{p} ≡ ( \begin{matrix}{p}_{1} \\ ⋮ \\ {p}_{K}\end{matrix} )$$

The model weights w may be found through a learning procedure that optimizes the prediction error on a set of M training samples (\vec{a}₁, \vec{p}₁) . . . (\vec{a}_{M}, \vec{p}_{M}). The performance of the trained model may then be evaluated on a set of samples to estimate classification performance on unseen samples.

In EAs, complex business processes underlie the classification problems. In most cases, it is not clear which features may be used properly for training purposes. For example, a situation may occur where N features may be used for training, but only L<N are available at an inference time. N may be the number of elements in the set of features that is used for training, which may also include features that are not available at inference time. L may be the number of elements in the subset of the N features that is non-empty at inference time. Inference time refers to the point in time when in an actual production system, new data is input to the model and the model makes a prediction.

If the N−L features are not present at inference time and carry information that helps the ML model to classify samples, this may typically lead to poor ML model performance when in actual production. Even if the information is essentially redundant and other features may also be used to find the correct class, the performance may be poor. When L<N, the ML model may have based its prediction on a feature that is not available at inference time.

In some cases, certain features may occur only in the data that is used for training the ML model and not in production data. If it is known which of the training set features are not available at inference time, these would naturally be removed from the training dataset. In the present disclosure, it is described how to handle situations for when features of the training dataset may be absent, or not present in an unmodified form, at inference time and it may not be manually verified that these features from the training dataset will not be available at inference time.

Features that are absent may be further mitigated by certain types of data augmentation during the ML model training. Instead of training on a dataset that has all the features present for each sample, features may be, for each sample, randomly dropped or replaced by dummy values with a small probability p_{drop}, such a p_{drop}=0.1. Dropping may be done on a per sample basis. Specifically, without augmentation, all the features for the sample are present. But with data augmentation, each sample, on average, has some of its features dropped, but may be different from sample to sample By training with this type of data augmentation, model overfitting may be avoided on certain patterns that are only present in the training data.

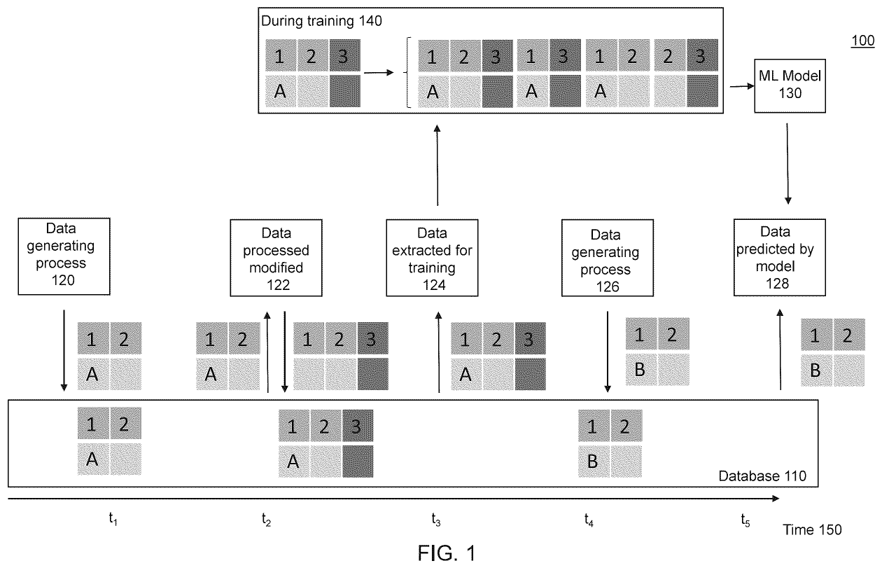

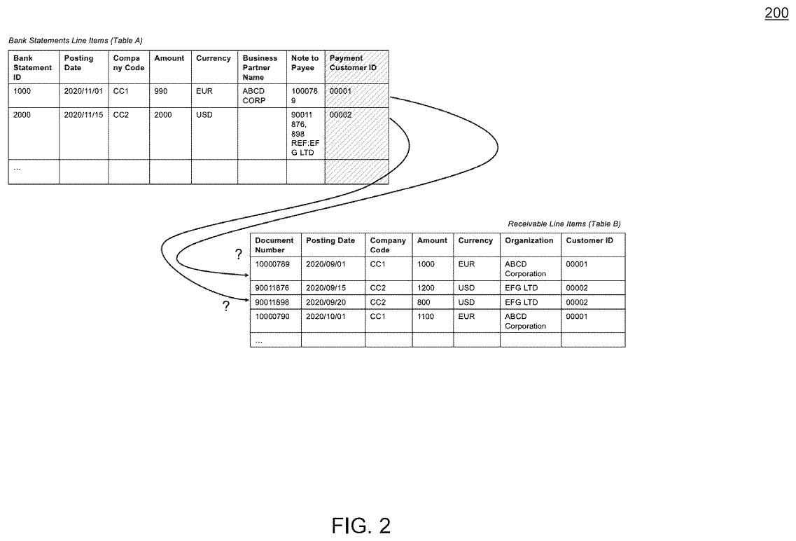

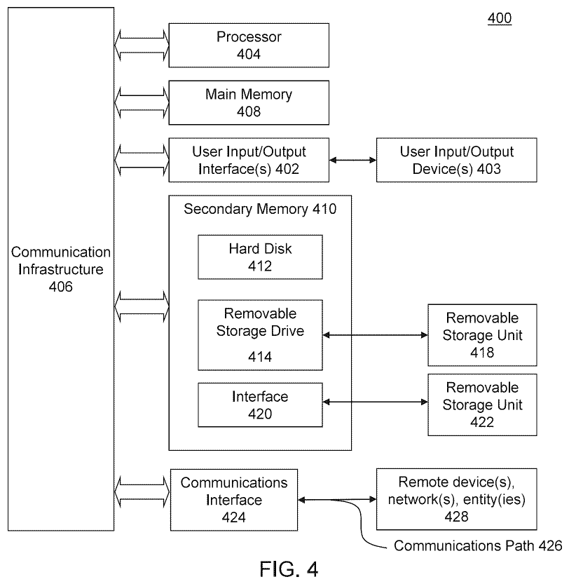

FIG. 1 depicts an illustration of a process 100 for dropping or replacing data from datasets and training ML models to avoid overfitting in training data over time, according to some embodiments. As a convenience and not a limitation, FIG. 1 may be described with reference to elements of FIG. 2. Process 100 may represent the operation of dropping or replacing data from datasets and training ML models to avoid overfitting in training data. Process 100 may also be performed by computer system 400 of FIG. 4. But process 100 is not limited to that embodiment, and other systems may be used to perform the method as will be understood by those skilled in the art. It is to be appreciated that not all operations may be needed, and the operations may not be performed in the same order as shown in FIG. 1.

The process 100 is depicted over time 150 with data in a database 110. Data may be originally created in a data generating process 120 from the database 110 at a time t₁. The data may additionally come from a user or another system and the database 110 would store the generated data. The data may be processed and modified in 122 at a time t₂. The data processed and modified in 122 may be done by a user or algorithmically by the database 110.

Information resulting from the processing in 122 may be used to update the data. Specifically, an additional field in the data might be filled, such as a column being added, represented by “3” in FIG. 1, or the data may be modified in other ways. By modifying the data, the data's representation in in the database 110 may be different from the original data.

Data may then be extracted for training in 124 at a time t₃. The data extracted may be used to assist in training a ML model or to automate the processing. New data may be generated by the data generating process 126 at a time t₄. This data may be predicted on, or classified, correctly the trained and deployed ML model 128 at a time t₅.

Previously, in the data extracted for training in 124, the ML model may only encounter the modified data and be able to learn from the modified data, which may have different patterns than the original data generated from the data generating process 120 or 126. This may lead to poor predictions in the data predicted by ML model 128. The solution of the present disclosure provides that once the data is extracted for training in 124, an extra step is added during training 140, which will now be described.

During training 140, dummy values, features of the data, denoted here by column headers 1, 2, or 3 in FIG. 1, may be statistically dropped or replaced on a sample by sample basis, which may increase the variety of features in the training data, and which may include variations where part of the modifications that happened in the data processing and modifying in 122 are not present. The dropped or replaced features may be seen during training 140, where, for example, column 3 may be dropped or replaced. For example, if the data started with 1, 2, and 3, the 2 may be dropped and the data then only includes the 1 and 3. Specifically, 1, 2, and 3 may represent the columns or features that may need to be dropped. For example, in FIG. 2, those features may be Bank Statement ID, Amount, or Payment Customer ID. A may be a value in column 1 of a particular sample. A may be originally created in the data generating process 120, whereas B is created in the data generating process 126.

FIG. 2 depicts a real world example of an entity matching problem 200, according to some embodiments. As a convenience and not a limitation, FIG. 2 may be described with regard to elements of FIG. 1. Process 200 may represent the operation of dropping or replacing data from datasets and training ML models to avoid overfitting in training data. Process 200 may also be performed by computer system 400 of FIG. 4. But process 200 is not limited to that embodiment, and other systems may be used to perform the method as will be understood by those skilled in the art. It is to be appreciated that not all operations may be needed, and the operations may not be performed in the same order as shown in FIG. 2.

Two tables are depicted in FIG. 2, one with query entities, which may be referred to as payments and the other one with invoices. The task is to match payments to invoices and the data extraction process 124 would extract the two tables and a third table, which is further represented by the line with arrows in FIG. 2, with information on how the entities of the two tables were matched. In the extracted data, the gray hatched column “Payment Customer ID” contains values created only in 122. When the data is extracted for prediction using the machine learning model in 128, the column “Payment Customer ID” may be empty.

Process 200 may include a task of matching payments to invoice records. For example, in FIG. 2, data from, for example, a cash application (app) is displayed. In the cash app, incoming payments must be matched with the outgoing invoices. A company may generate a set of records of cleared sets of payments and invoices. The company may send out invoices to their business partners and then want to clear these invoices against incoming payments, to show that the invoice was actually paid.

The matching bank statement line items, as seen in Table A of FIG. 2, may be matched with candidate invoice line items, as seen in Table B of FIG. 2. The field “Payment Customer ID” in Table A contains the ID of a customer. If this field is included in the training data set, a ML model might learn that this field must be matched exactly to the field “Customer ID” from the invoice record in Table B. This match is a necessary condition for the pair to be considered a match. However, the field “Payment Customer ID” is only filled out by an employee or accountant after a set of invoices has been clear against a payment. The future information that is only available after matching may be referred to as a leaking field. The leaking field may be absent when a ML model is used for matching bank statements to invoices in production. The field of “Payment Customer ID” may be filled manually after clearing and should not be used for matching the ML model.

Features that may dropped or replaced may be in in both the query and target documents, which in FIG. 2 may be the bank statement and receivable line items. The value of a given feature would only be dropped from either the query or the target document, depending where it occurs as usually query and target documents have non-overlapping fields. In the special case where query and target document have the same feature set (e.g. for finding groups in a single table), the value of same feature may be dropped in both documents (query and target).

The data may also contain other features that may allow for identifying the correct customer, such as “Business Partner Name” being matched to “Organization” or “Note to payee” being matched to “Organization.” This matching in FIG. 2 allows for a ML model trained without the feature “Payment Customer ID” to be able to learn whether a candidate pair has matching customers or not.

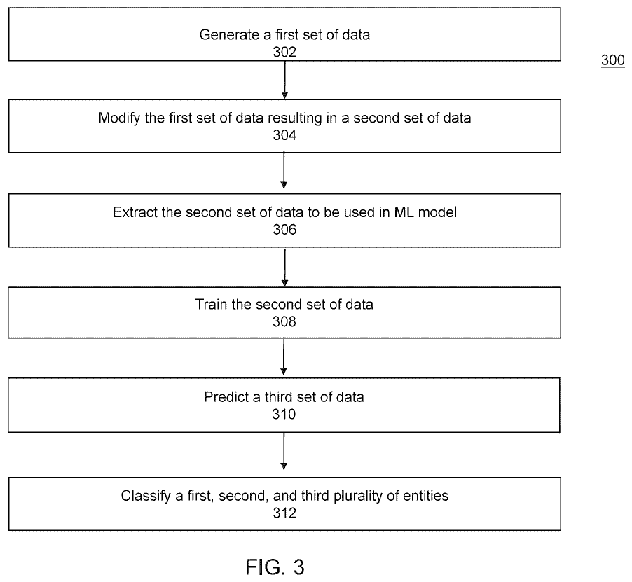

FIG. 3 illustrates a method of entity matching by dropping or replacing data from datasets and training ML models to avoid overfitting in training data, according to some embodiments. As a convenience and not a limitation, FIG. 3 may be described with regard to elements of FIGS. 1 and 2. Method 300 may represent the operation of dropping or replacing data from datasets and training ML models to avoid overfitting in training data Method 300 may also be performed by computer system 400 of FIG. 4. But method 300 is not limited to that embodiment, and other systems may be used to perform the method as will be understood by those skilled in the art. It is to be appreciated that not all operations may be needed, and the operations may not be performed in the same order as shown in FIG. 3.

In 302, a first set of data may be generated. The first set of data may comprise a first plurality of entities. For example, in 302, a processor may generate data from a database 110, as in FIG. 1, at the data generating process 120. Additionally, the data may come from a user or another system and the database 110 would store the generated data. The data may include rows A and columns 1, 2, and 3, as seen in FIG. 1.

In 304, the first set of data may be modified by processing the first set of data. The modifying may result in a second set of data. The second set of data may comprise a second plurality of entities. Additionally, at least one entity of the first or second plurality of entities may be absent at an inference time. For example, in 304, the data described in 302 may be processed and modified in 122, as seen in FIG. 1. For example, a third column 3 may be added and modified, as seen in FIG. 1.

In 306, the second set of data may be extracted. The second set of data may be used in a ML process based at least in part on at least one ML model. For example, in 306, the data described in 304 may be extracted for training in 124, as seen in FIG. 1. The data may be used in the ML model 130. Additionally, the second set of data may be augmented.

In 308, the second set of data may be used to train at least one ML model. The training may comprise statistically dropping at least one feature from the second plurality of entities and/or replacing at least one other feature of the second plurality of entities with a dummy value. For example, in 308, during training 140, the dummy values seen in FIG. 1, such as A, 1, 2, or 3, may be statistically dropped or replaced.

In 310, a third set of data may be predicted based on the at least one ML model. The third set of data may comprise a third plurality of entities. For example, in 310, data created in the data generating process 126 may be predicted using the ML model 130.

In 312, the third plurality of entities contained in the third set of data may be classified by a class. The classifying may comprise assigning a probability to each of the first, second, and third plurality of entities for the class. Additionally, the class may be at least one of a match, a partial match, or not a match. For example, in 312, the data predicted by the ML model 128, as seen in FIG. 1, may then be classified.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc using orderings different than those described herein.

References herein to “one embodiment.” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for entity matching, comprising:
generating, by at least one processor, a first set of data, wherein the first set of data comprises a first plurality of entities;
modifying, by the at least one processor, the first set of data by processing the first set of data resulting in a second set of data, wherein the second set of data comprises a second plurality of entities;
extracting, by the at least one processor, the second set of data to be used in a machine learning (ML) process based at least in part on at least one ML model;
training, by the at least one processor, the second set of data on at least one ML model;
predicting, by the at least one processor, a third set of data based on the at least one ML model, wherein the third set of data comprises a third plurality of entities; and
classifying, by the at least one processor, the first, second, and third plurality of entities by a class.

2. The method of claim 1, the training further comprising:
statistically dropping at least one feature from the second plurality of entities.

3. The method of claim 1, the training further comprising:
replacing at least one feature from the second plurality of entities with a dummy value.

4. The method of claim 1, the training further comprising:
statistically dropping at least one feature from the second plurality of entities and replacing at least one other feature from the second plurality of entities with a dummy value.

5. The method of claim 1, the extracting further comprising:
augmenting the second set of data.

6. The method of claim 1, wherein at least one entity of the first or second plurality of entities is absent at an inference time.

7. The method of claim 1, wherein the class is at least one of a match, a partial match, and not a match.

8. A system, comprising:
a memory; and
at least one processor coupled to the memory and configured to:
generate a first set of data, wherein the first set of data comprises a first plurality of entities;
modify the first set of data by processing the first set of data resulting in a second set of data, wherein the second set of data comprises a second plurality of entities;
extract the second set of data to be used in a machine learning (ML) process based at least in part on at least one ML model;
train the second set of data on at least one ML model;
predict a third set of data based on the at least one ML model, wherein the third set of data comprises a third plurality of entities; and
classify the first, second, and third plurality of entities by a class.

9. The system of claim 8, wherein to train, the at least one processor is further configured to:
statistically drop at least one feature from the second plurality of entities.

10. The system of claim 8, wherein to train, the at least one processor is further configured to:
replace at least one feature from the second plurality of entities with a dummy value.

11. The system of claim 8, wherein to train, the at least one processor is further configured to:
statistically drop at least one feature from the second plurality of entities and replace at least one other feature from the second plurality of entities with a dummy value.

12. The system of claim 8, wherein to extract, the at least one processor is further configured to:
augment the second set of data.

13. The system of claim 8, wherein at least one entity of the first or second plurality of entities is absent at an inference time.

14. The system of claim 8, wherein the class is at least one of a match, a partial match, and not a match.

15. A non-transitory computer-readable device having instructions stored thereon that, when executed by at least one computing device, causes the at least one computing device to perform operations comprising:
generating a first set of data, wherein the first set of data comprises a first plurality of entities;
modifying the first set of data by processing the first set of data resulting in a second set of data, wherein the second set of data comprises a second plurality of entities;
extracting the second set of data to be used in a machine learning (ML) process based at least in part on at least one ML model;
training the second set of data on at least one ML model;
predicting a third set of data based on the at least one ML model, wherein the third set of data comprises a third plurality of entities; and
classifying the first, second, and third plurality of entities by a class.

16. The non-transitory computer-readable device of claim 15, the training further comprising:
statistically dropping at least one feature from the second plurality of entities.

17. The non-transitory computer-readable device of claim 15, the training further comprising:
replacing at least one feature from the second plurality of entities with a dummy value.

18. The non-transitory computer-readable device of claim 15, the training further comprising:
statistically dropping at least one feature from the second plurality of entities and replacing at least one other feature the second plurality of entities with a dummy value.

19. The non-transitory computer-readable device of claim 15, the extracting further comprising:
augmenting the second set of data.

20. The non-transitory computer-readable device of claim 15, wherein the class is at least one of a match, a partial match, or not a match.
